(19) United States
(12) Patent Application Publication
(10) Pub. No.: US 2011/0213599 A1
(43) Pub. Date: Sep. 1, 2011

(54) Method of Sizing Actuators for a Biomimetic Mechanical Joint

(75) Inventors: Stephen C. Jacobsen, Salt Lake City, UT (US); Marc X. Olivier, Sandy, UT (US); Brian J. Maclean, Salt Lake City, UT (US)

(73) Assignee: Raytheon Company, Waltham, MA (US)

(21) Appl. No.: 13/061,472

(22) PCT Filed: Aug. 28, 2009
(86) PCT No.: PCT/US09/55440

§ 371 Date: May 23, 2011

Related U.S. Application Data
(60) Provisional application No. 61/092,697, filed on Aug. 28, 2008.

(51) Int. Cl. G06F 17/50

(52) U.S. Cl. 703/7; 901/22; 901/15; 901/28

(57) ABSTRACT

A method of configuring a biomimetic mechanical joint for the efficient movement of a support member about a pivot device. The method includes providing a first fractional actuator and a second fractional actuator being operable with the support member and the pivot device, sizing the first fractional actuator for rated operation at a first boundary condition, and sizing the second fractional actuator so that the first and second fractional actuators, when recruited in combination, are rated for operation at a second boundary condition.

### RELATED APPLICATIONS

This application claims priority to U.S. Provisional Patent Application No. 61/092,697, filed Aug. 28, 2008, and entitled “Method Of Sizing Actuators For A Biomimetic Mechanical Joint”, which application is incorporated by reference in its entirety herein.

### FIELD OF THE INVENTION

The field of the invention relates generally to human-like robotic devices, and more specifically to the mechanical joints for powered prosthetic limbs, exoskeletons and human-like robots.

### BACKGROUND OF THE INVENTION AND RELATED ART

Significant advancements in the development of robots and robotic devices have been achieved in recent decades. Manufacturing efficiencies gained through the use of robotic assemblers and manipulators, exploratory robotic vehicles (such as those traveling the surface of Mars), and animatronics characters often seen at theme parks and other sights of attraction are but a few popular examples. Each of these specialized robots have common characteristics, however, in that they do not have true human-like capabilities, nor do they function with human-like operation. Indeed, many robotic devices are tethered to external power sources, while others are configured to move without bi-pedal or human-like locomotion. True mobile and un-tethered human-like robots and exoskeletons, while in existence, are in the early stages of development, and are continually being improved to better participate in mobile, human-like activities.

One reason for the continuing technological difficulty in advancement of human-like, or biomimetic, robotic systems toward un-tethered human-like robotic activity is the inefficiency inherent within the mechanical joints that provide the robots with the ability to move. In a robotic device, movement about a mechanical joint is a primary consumer of power. Yet with few exceptions the mechanical joints in robots and human assistance devices have been optimized for control and performance, these taking precedence over optimal efficiency considerations. For instance, many modern non-biomimetic industrial robots perform significant work with the advantage of being permanently connected to external electrical, fluid or mechanical power systems that can supply a surplus of power, leading to articulating joints capable of precise and powerful movements, but which are also highly wasteful of energy.

Efficiency has also suffered in powered prosthetic limbs as these devices have been primarily confined to the laboratory, research centers, or individuals living in populated areas with ready access to sources of power. In a remote work or battlefield environment, however, efficiency is critical for long-term operation and/or survivability, as an exoskeleton or human-like robot is useless if it prematurely runs out of fuel or discharges its batteries. Advancements in more efficient operation of human-like robotic devices or exoskeletons, particularly more efficient operation of the biomimetic joints through a range of movements and load conditions, without sacrificing speed or power, are greatly needed and will serve to provide improved, un-tethered human-like robotic activity.

### SUMMARY OF THE INVENTION

The human body can be one model for optimizing the mechanical joints in exoskeletons and human-like robots for efficiency. The bodies of all species in the animal kingdom, including humans, have been selected over time for highly-efficient operation, in order to function and survive with only a last meal or stored fat for energy. The ability to emulate the efficient movement of a human limb around a natural joint can be provided, at least in part, with a biomimetic mechanical joint.

In the present invention, this includes providing a biomimetic mechanical joint with the ability to move a limb segment or support member about a pivot device using multiple fractional actuators sized for separate and distinct response characteristics, similar to the way individual muscles and muscles groups in the human body are configured to efficiently rotate a natural joint. The fractional actuators can be selectively recruited during operation, either individually or together, to efficiently rotate the support member about the mechanical joint throughout a range of movements and under a variety of load conditions. The invention can include the method of sizing a first fractional actuator of a biomimetic mechanical joint for rated operation at a first boundary condition, and sizing a second fractional actuator, when recruited in combination with the first fractional actuator, for rated operation at a second boundary condition.

As embodied and broadly described herein, the present invention resides in a method for sizing actuators for the efficient movement of a limb segment or support member or about a pivot device throughout a range of operating states, which range can include a stumble-recovery mode, a running mode, a walking mode, a squatting mode and a stepping mode. The method includes sizing a first fractional actuator for rated operation at a first boundary condition that is derived from a first operating state, such as the stumble-recovery mode. The method further includes sizing a second fractional actuator, when recruited in combination with the first fractional actuator, for rated operation at a second boundary condition derived from a second operating state, such as the stepping mode.

### BRIEF DESCRIPTION OF THE DRAWINGS

Features and advantages of the invention will be apparent from the detailed description that follows, and which taken in conjunction with the accompanying drawings, together illustrate features of the invention. It is understood that these drawings merely depict exemplary embodiments of the present invention and are not, therefore, to be considered limiting of its scope. And furthermore, it will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings, in which:

FIG. 1 illustrates a perspective view of an exemplary exoskeleton having a biomimetic mechanical joint which has been sized according to the method of the present invention;

FIG. 2 illustrates a side view of an exemplary biomimetic mechanical joint which has been sized according to an exemplary embodiment of the method of the present invention;

FIG. 3 illustrates a close-up side view of the embodiment of FIG. 2;

FIG. 4 illustrates a close-up perspective view of the embodiment of FIG. 2;

FIG. 5 is a plot illustrating representative demand and generated absolute-value speed-torque curves characteristic of an actuated mechanical joint as known in the prior art;

FIG. 6 is a plot illustrating representative demand and generated absolute-value speed-torque curves characteristic of a biomimetic mechanical joint that has been configured in accordance with an exemplary embodiment of the present invention;

FIG. 7 is a flowchart depicting a method of configuring a biomimetic mechanical joint, in accordance with an exemplary embodiment of the present invention;

FIG. 8 is a flowchart depicting a method of configuring a biomimetic mechanical joint, in accordance with another exemplary embodiment of the present invention;

FIG. 9 illustrates a schematic diagram of an exemplary biomimetic mechanical joint which has been sized according to an exemplary embodiment of the method of the present invention;

FIG. 10 illustrates a front view of another exemplary exoskeleton having a biomimetic mechanical joint which has been sized according to the method of the present invention;

FIG. 11 illustrates a side view of the exemplary exoskeleton of FIG. 10;

FIG. 12 illustrates a close-up side view of the exemplary exoskeleton of FIG. 10;

FIG. 13 illustrates a sectional view of yet another biomimetic mechanical joint which has been sized according to the method of the present invention;

FIG. 14 illustrates a close-up side view of yet another biomimetic mechanical joint which has been sized according to the method of the present invention; and

FIG. 15 illustrates a close-up perspective view of the embodiment of FIG. 14.

### DETAILED DESCRIPTION OF EXEMPLARY EMBODIMENTS

The following detailed description of the invention makes reference to the accompanying drawings, which form a part thereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. As such, the following more detailed description of the exemplary embodiments of the present invention is not intended to limit the scope of the invention as it is claimed, but is presented for purposes of illustration only: to describe the features and characteristics of the present invention, and to sufficiently enable one skilled in the art to practice the invention. Accordingly, the scope of the present invention is to be defined solely by the appended claims.

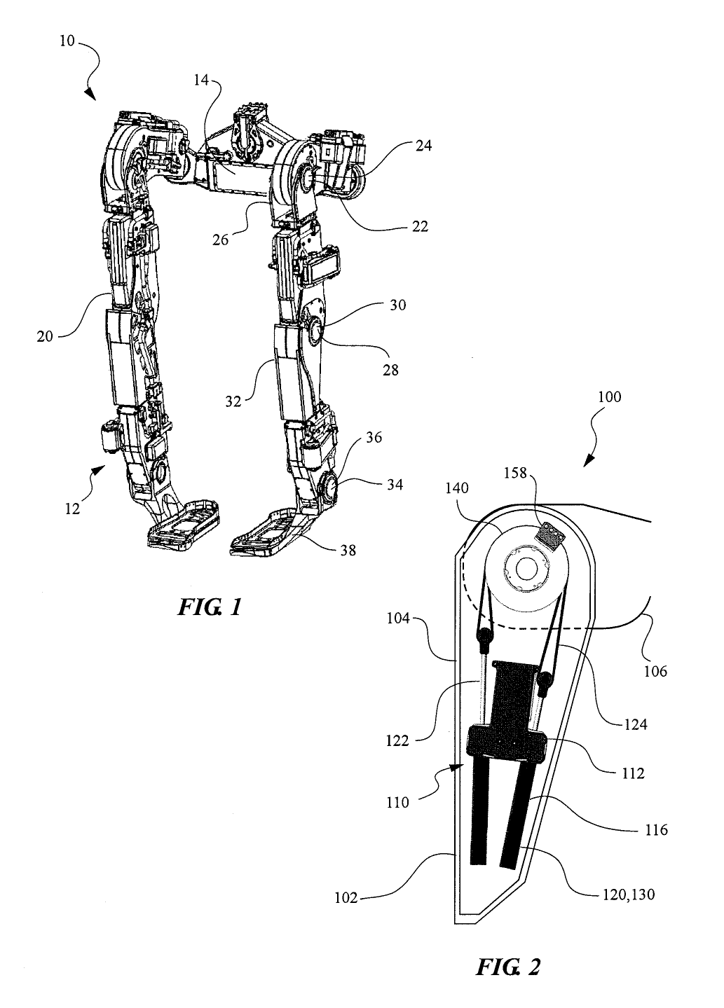

Illustrated in FIGS. 1-15 are various exemplary embodiments of a method and system for sizing the actuators of biomimetic mechanical joints that can be integrated into powered prosthetic limbs, exoskeletons, human-like robots or robotic devices, etc. In some exemplary embodiments, the biomimetic mechanical joint uses a plurality of fractional actuators, both individually or in combination, to meet the motion requirements of the mechanical joint about a single degree-of-freedom (“DOF”) axis. The present invention can be distinguished from the prior art which uses a single 100% actuator system to generate movement about the same axis. Using multiple fractional actuators, instead of one 100% actuator, can lead to significant improvements in both efficiency and performance.

A “fractional” actuator can be defined as an actuator that meets less-than-100% of the maximum design torque of a biomimetic mechanical joint, which is the standard design point for most actuation systems. A first fractional actuator can be combined with at least one other fractional actuator so that the set of fractional actuators, operating together, meets the maximum design torque requirement of the mechanical joint. While the number of fractional actuators can be three or more, it is to be appreciated that an actuation system with just two fractional actuators can provide significant improvements over the prior art which uses a single, 100% actuator to meet the maximum design torque requirement.

The fractional split between a two fractional antagonistic actuator system can range anywhere from 95/5 to 50/50, and can further vary among the locations of the biomimetic mechanical joints throughout the humanoid robotic body. The optimum ratio will depend upon the performance boundary conditions of the mechanical joint, and will vary considerably upon the designated purpose of the robotic body (e.g. general purpose, heavy lifting, running, climbing assist, etc.) and the type and configuration of the actuators in the actuator system. However, a biomimetic mechanical joint with two fractional antagonistic actuators configured for optimal efficiency can have a fractional split generally ranging between 80/20 and 60/40.

As stated above, the biomimetic mechanical joint can comprise a set of multiple fractional actuators which operate to rotate a limb segment or support member about a pivot device, and can be applied to any major load-bearing joint in a human-like robotic body, including but not limited to, the hip, knee, ankle, shoulder, elbow, wrist, etc. Each biomimetic mechanical joint can be further defined as the assembly which includes both the pivot device, the actuators, and the attached, movable support member. For instance, a biomimetic hip can include the hip joint and the upper leg support member. In a similar fashion, a biomimetic knee can include both the knee joint and the lower leg, and the biomimetic ankle can include the ankle joint and the foot, etc.

The present invention can provide several significant advantages over prior-related mechanical joints, some of which are recited here and throughout the following more detailed description. First, the biomimetic mechanical joint can be significantly more efficient than the mechanical joints in existing prosthetic limbs, exoskeletons, human-like robots or robotic devices using a single, 100% actuator system. One reason for the improved efficiency is that fractional actuators creating motion about each DOF axis better emulate the structure of the human body, which naturally uses only just enough muscle (or power) to meet the performance required of the joint or limb at any particular time. In other words, energy is conserved in a human joint by selectively recruiting, or activating, only the muscles or muscle groups needed move the attached support member or support member in the desired manner under the current load.

Single, 100% actuator systems have a disadvantage in that all of the output of the actuator must be activated all of the time. So, unless the actuator is operating at its optimum design point, it is wasting energy. For example, in a hydraulic system using a hydraulic cylinder sized to the maximum torque requirement, the wasted energy can be embodied in the excess high-pressure hydraulic fluid that is used to move the hydraulic piston under a little or no load. Moreover, as the motion of the actuator may be excessively fast even when there is a load to press against, the high-pressure fluid is often throttled by the pressure control valve so that the support member moves at a slower, more desirable pace. Both the use of excess fluid and throttling are examples of wasting the potential energy contained in the pressurized hydraulic fluid.

The present invention biomimetic mechanical joint overcomes the inherent disadvantages of the prior art by splitting the single actuator per DOF into two or more fractional actuators per DOF. In essence, using a plurality of fractional actuators creates a gear shifting scenario in which the one or more actuators can be selectively recruited to efficiently meet all the operating scenarios that may be required of the joint. Thus, at any particular operating condition which is less than the maximum design torque condition for the joint, one or the other or both of the fractional actuators can be operating near its optimum and most efficient design point.

It can be appreciated by one of skill in the art that configuring the plurality of fractional actuators to function effectively throughout the entire operating range requires that the actuators be first sized to meet the extreme conditions defining the limits of that range. The two boundary conditions defining the limits of that range comprise the maximum design torque at zero speed (also known as the low-speed/high-torque boundary condition), and the maximum rotational speed of the mechanical joint under zero additional load (also known as the high-speed/low-torque boundary condition).

According to the method of the present invention, a first fractional actuator can be configured to meet the demands of a high-speed, quick-response operating state, such as when a leg must move quickly to catch the body during a stumble and to recover balance without falling (e.g. stumble-recovery). This operating state may be consistent with the high-speed/low-torque boundary condition at one end of the operating range. Furthermore, both the first and a second fractional actuators can be sized so that together they meet the other boundary condition, which is the low-speed/high-torque response state. In doing so, the second fractional actuator can be individually sized by subtracting the contribution of the first fractional actuator from the low-speed/high-torque boundary condition.

The method of the present invention improves efficiency without sacrificing performance by separating the single actuator into two or more actuators, which are then sized for rated operation that meets the two boundary conditions relating to speed and load capacity. Rated operation can be defined as operation at 100% of design limit, whether those design limits are generated torque, acceleration, speed of motion, flow rates, etc. Most actuators can operate at levels substantially less than 100% of design, such as with throttling of the pressurized hydraulic fluid as it passes through the pressure valve, or reducing the voltage to a motor drive, etc. Such throttling or reduction in voltage at non-100% design levels is inefficient. In some exemplary embodiments of the present invention, the fractional actuators driving the biomimetic mechanical joint are allowed to operate at or near rated power during all operating states, as this is the most efficient operating point.

This operating strategy is similar to the geared transmission system in a motorized vehicle, which allows the engine to operate at its most efficient or most powerful operating points even while the vehicle is moving at different speeds. For instance, a vehicle transmission system typically has three or more gears that split the operating range of the vehicle into three or more operating regions, ranging from low speed, high torque (starting from rest) to high-speed, low-torque (overdrive on the freeway). With the geared transmission system, the engine can power the vehicle near its optimum efficiency or power points as the vehicle moves through all operating regions, which the engine could not do if it were directly connected to the wheels.

In a similar fashion, the method of the present invention allows the fractional actuators to be configured so they can operate together or individually to create three or more operating regions. In a biomimetic joint that uses two fractional actuators, one actuator can be larger than the other. Both fractional actuators can be sized (or torque rated) together for the low-speed/high-torque operating region. The smaller fractional actuator also can be individually sized (or speed rated) for optimal performance in the high-speed/low-torque operating region. The larger fractional actuator can therefore function as the middle gear, to fill the gap between the combined low-speed/high-torque operation and smaller actuator's high-speed operation. With an actuation system built according to the method of the present invention, throttling may still be used to meet non-rated operating conditions. As will be seen, however, the degree of throttling can be greatly reduced across the operating range of the multiple fractional actuators in comparison to an actuation system built with a single, 100% actuator.

It can be appreciated that there is little room for a gear system within the support member, which would allow the first, second, third or higher gears to be selectively inserted and removed from the power transmission path. Moreover, even if there were space available, there may not be enough time to switch gears as the actuators may require near-instantaneous activation. Thus, it can be desirable for each fractional actuator of a biomimetic mechanical joint to have its own coupling path to the pivot device. When one or the other fractional actuators is individually recruited to power the biomimetic mechanical joint, however, there can be a means for disengaging or disconnecting the other non-recruited actuator from the power path, so that while the inactive actuator is not contributing to the forces driving the joint, it is not creating excess drag on the system either. As will be discussed in more detail hereinafter, this disengagement can occur in a variety of manners, including physical disconnection of the actuators from the pivot device, fluidic disengagement between the actuators and the pivot device, or electrical disconnection between a motor and a power supply, etc.

In implementing the method of the present invention described above, it is to be appreciated that a variety of fractional actuators types and configurations can be used in the biomimetic mechanical joint, each with their own advantages and disadvantages. For instance, the fractional actuators can include fluid power systems (e.g. hydraulics, pneumatics, etc.) or electric power systems (e.g. motors, etc.). Fluid powered systems can offer near-instantaneous power at a high density, while electrical systems can offer reliable performance with few moving parts.

If the fractional actuators are hydraulic cylinders, the effective area of the actuators can be sized by controlling the diameters of the cylinder's inner bore and piston rod. For a given volume of fluid entering the cylinder, it can be appreciated that more linear movement is generated per volume of fluid with a cylinder having a smaller diameter than with a cylinder having a larger diameter. In conjunction with the greater movement, however, the reduced surface area of the smaller piston provides significantly less force, so that the small-diameter piston can only move a proportionately smaller load for a given supply pressure. Thus, a smaller diameter hydraulic cylinder can provide more efficient operation for the biomimetic mechanical joint engaging in high-speed/low-torque activity by reducing the throttling losses. In contrast, the cylinder with a larger internal bore can move a greater load, but only at a slower rate of movement since it will take longer for the constant inflow of hydraulic fluid to displace the piston with the larger diameter the same distance.

The method of the present invention is further advantageous in that it can be applied to fractional actuators having a variety of configurations, such as single-acting linear antagonistic actuator pairs that rotate the pivot device with a pulley and tendon system, double-acting linear actuators attached to the pivot device with a rigid linkage, rotary actuators integrated into the pivot device, etc.

Each of the above-recited advantages will be apparent in light of the detailed description set forth below and best understood with reference to the accompanying drawings, wherein the elements and features of the invention are designated by numerals throughout. These advantages are not meant to be limiting in any way. Indeed, one skilled in the art will appreciate that other advantages may be realized, other than those specifically recited herein, upon practicing the present invention.

Illustrated in FIG. 1 is an exemplary embodiment of an exoskeleton 10, which can provide a platform for the various biomimetic mechanical joints which have been sized according to the method of the present invention. The exoskeleton has the potential to provide mechanical assistance to humans in a variety of situations, including increased mobility for the handicapped, augmented physical labor, enhanced soldiering activities, etc. As shown, the exoskeleton can include a whole-body support frame. In another embodiment it can also include a partial body frame, such as the lower body walking portion, or can even be embodied in individual limbs. The biomimetic mechanical joint can be applied to any load-carrying support member on the exoskeleton, such as within one or more joints in the legs or lower half of the body.

As shown in FIG. 1, the exoskeleton 10 can include a lower body portion 12. The lower body portion can include a pelvic region 14 to which are attached the two legs 20, each of which can be further comprised of a hip joint 22, a knee joint 28 and an ankle joint 34. For the purposes of this application, the biomimetic mechanical joint can be defined as the assembly which includes the pivot device, the attached rotary support member and the actuator sub-assembly. The actuator sub-assembly can often be mounted inside the rotary support member. The biomimetic mechanical hip joint 22 can therefore comprise the hip pivot device 24 and the upper leg or thigh support member 26, the knee joint 28 can comprise the knee pivot device 30 and the lower leg or calf support member 32, and the ankle joint 34 can comprise the ankle pivot device 36 and the foot support member 38.

Illustrated in FIG. 2 is a side view of one exemplary embodiment 100 of a biomimetic mechanical joint that could be applied to any of the load bearing joints of the exoskeleton or human-like robotic device. The biomimetic mechanical joint 100 can have a rigid outer shell 104 surrounding the pivot device 140 and forming the rotary support member 102 of the mechanical joint. Two fractional actuators 116, in this case two single-acting antagonistic actuator pairs 120, 130 can be included in an actuator sub-assembly 110 that is driven by a control system mounted within a control body 112 located between the antagonistic actuator pairs. Tendons 124 can be coupled at both ends to the actuator pistons 122 extending from the antagonistic actuator pairs 120, and at a midsection to a tendon attachment block 158 mounted to the pivot device. In the exemplary embodiment 100 of the biomimetic mechanical joint shown in FIG. 2, actuator sub-assembly 110 can be mounted to the inside of the rigid shell 104 of the rotary support member 102, while the pivot device 140 can be fixed relative to a base support member 106. By way of an illustrative example, if the biomimetic mechanical joint were integrated in the hip joint of the exoskeleton of FIG. 1, the joint's actuator sub-assembly could be mounted to the inside of the upper leg or thigh support member while the hip pivot device was fixed relative to the pelvic region. In an alternative aspect of the biomimetic mechanical joint, however, the actuator sub-assembly can be mounted to the base support member 106 (in this case the pelvic region) and the pivot device 140 can be fixed relative to the rotary support member 102 (or the upper leg support member).

Although many of the embodiments described herein locate the actuator sub-assembly inside the rotary support member, it is to be appreciated that either configuration can allow for powered rotation of the rotary support member relative to the base support member by the biomimetic mechanical joint. Furthermore, the base support member can comprise a rigid body section of the human-like robotic device, such as the torso, as well as the rotary support member of an adjacent joint.

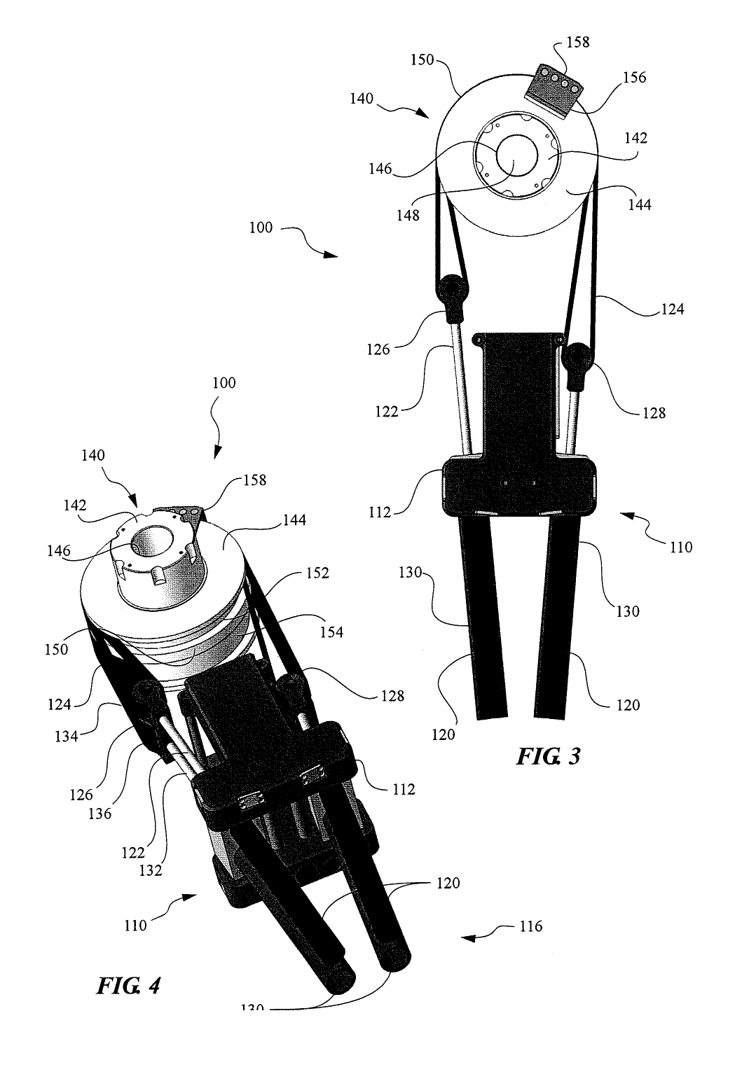

To better illustrate the configuration of the fractional actuators, tendons, and pivot device, the exemplary biomimetic mechanical joint of FIG. 2 is shown in more detail in FIGS. 3 and 4 without the rigid outer shell. The two fractional actuators 116 included in the actuator sub-assembly 110 can be further comprised of two antagonistic actuator pairs 120, 130. Each antagonistic actuator pair can be considered a single fractional actuator, since each individual actuator in the antagonistic actuator pair is a linear, single-acting actuator that can only move the support member about the pivot device in one direction (e.g. pulling of a tendon attached to a pivot device). The fractional actuators described above, however, can be configured for rotation in both directions. Therefore, for the exemplary biomimetic mechanical joint in FIGS. 2-4, the two single-acting actuators and tendon in one antagonistic actuator pair can together be considered a single fractional actuator for the purposes of discussion of the method of the present invention.

It is to be further appreciated that although two fractional actuators, or antagonistic actuator pairs, are used in the representative embodiment of FIGS. 2-4, additional multiples of fractional actuators, such as three or four fractional actuators, etc., can also be used and should be considered to fall within the scope of the present invention.

The two antagonistic actuator pairs can also be of different sizes, including a large actuator pair 130 and a small actuator pair 120. Moreover, each antagonistic actuator pair in the exemplary biomimetic mechanical joint in FIGS. 2-4 can have symmetric actuators, meaning that both single-acting actuators in the same pair are of similar size and configuration, and can generate equivalent substantially forces in both directions.

If the fractional actuators are hydraulic cylinders, one actuator pair can be provided with small actuation area hydraulic cylinders that are sized for high-speed/low-load conditions. As previously mentioned, for a given flowrate of fluid from the control body 112, the small diameter actuator pair will rotate the pulley faster than the large diameter pair, but with reduced force for a given hydraulic fluid pressure. For the same flowrate and pressure actuator pair with the larger actuation area will rotate the pulley at a slower rate, but with more force pulling on the tendon, since the force imparted by the actuator is directly proportional the surface area of the piston face.

The pivot device 140 can be further comprised of a pulley having a disc portion 144 and an axle portion 142. The pulley can rotate about a pivot post 148 which fits inside a center hole 146 in the axle portion of the pulley. The disc portion 142 can have an outer circumferential surface 150 into which are formed a plurality of tendon grooves 152, 154, with one groove for each tendon 124, 134 of each antagonist actuator pair 120, 130. Also formed in the circumferential surface can be an attachment slot 156 that axially bisects the tendon grooves and provides a location for a tendon attachment block 158 to be mounted to the pulley. Situated within the pivot post 148 or the center hole 146 can be a rotating interface such as a bearing or a bushing (not shown), which allows the pulley and the pivot post to rotate relative to one another.

Each antagonistic actuator pair 120, 130 can have two symmetrically-sized actuators linked together over the pivot device 140 with a tendon 124, 134. Although the tendons may be provided in a variety of sizes and cross-sectional shapes (e.g. circular, rectangular, v-shaped, etc.), each tendon in the embodiment 100 shown in FIGS. 2-4 can have a belt-shaped profile with a defined width and thickness, and can further be configured with dimensions that match with the width and thickness of the corresponding tendon groove 152, 154. Each tendon can also be coupled at their midsection to the attachment block 158 connected to the pivot device, which fixes the tendons to the pivot device and prevents slippage of the tendons within the grooves.

Alternatively, each tendon can be sub-divided into two shorter tendons, with one end of each shorter tendon coupled to a tendon attachment point on the pivot device and the other end of each tendon coupled to one of the actuators in the antagonistic actuator pair.

The ends of each tendon 124, 134 can be attached with end connectors 126, 136 to the ends of the actuator pistons 122, 132 by any means available in the art. In the embodiment shown, for example, the tendons can be made sufficiently long so that the ends can be looped back and connected to the attachment block 158, and the end connectors configured with connector rods 128 that fit within the tendon loops and that secure the tendons to the actuator pistons. The looped configuration can be advantageous by allowing for small movements of the tendons relative to the actuator pistons during operation as the tendons are alternately wrapped and unwrapped around the pulley, which movements can relieve stress and reduce wear, and further ensure that the load acting on the actuators 120, 130 is in pure tension.

The ends of the two tendons 124, 134 can be separately attached to their respective actuator pistons 122, 132 with the end connectors 126, 136 to allow relative movement between the two tendons in response to varying load conditions, e.g. a loaded tendon can stretch more than an unloaded tendon. For instance, if the large actuator pair 130 is active and the small actuator pair 120 is inactive or disengaged, the segment of the tendon 134 attached to the working large actuator can stretch slightly under load, while the segment of the tendon 124 for the adjacent small actuator can remain slack. Even though both tendons can be fixed to the pulley 144 with the attachment block 158, only the segment of the tendon 134 connected to the working, large actuator may pull on the pulley to rotate the pivot device 140. On the opposite side of the actuator sub-assembly 110, however, both the small and large inactive actuators can follow the movement of their respective tendons 124, 134 as they roll up onto the pulley 144 while the active working actuator rotates the support member about the pivot device.

In an alternative embodiment, the tendons 124, 134 can be linked together at the end connectors 126, 136 such as with a extra-long, common connector rod 128. And in another alternative embodiment, the two antagonistic actuator pairs can share a common end connector coupled to a single, double-wide tendon-belt.

An exemplary biomimetic mechanical joint for generating a variable torque between support members of a biomimetic robotic device is described in more detail in commonly-owned and co-pending Patent Application No. ______, filed Aug. 28, 2009, and entitled “Biomimetic Mechanical Joint” (Attorney Docket No. 2865-25027.PROV.PCT), which application is incorporated by reference in its entirety herein.

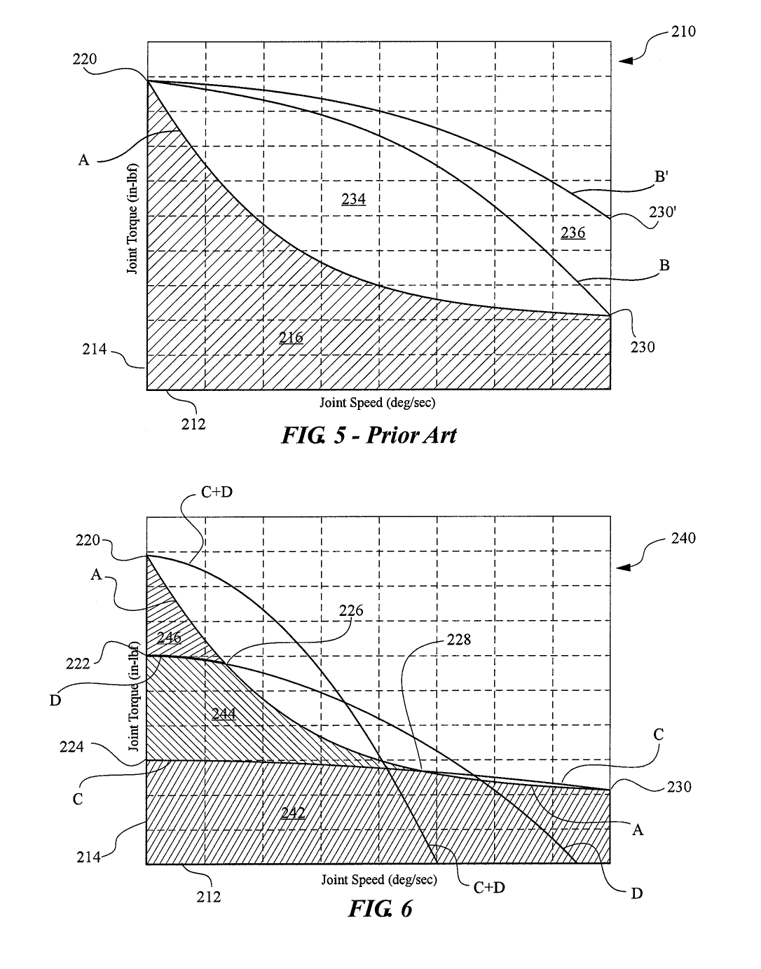

Illustrated in FIG. 5 is a plot 210 of several absolute-value speed-torque curves that can be used to model the speed-torque output that can be provided by a mechanical joint of the prior art utilizing a single 100% actuator. The X-axis 212 of the plot can define the speed of the joint in rotating the limb or support member about the pivot device, in units of degrees/second. The Y-axis 214 of the plot can define the torque which can be either generated by the actuators or required by the joint in rotating the support member about the pivot device, in units of in-lbf. The first speed-torque curve A is an illustrative example of a demand speed-torque curve, which exemplifies the torque that can be required by a mechanical joint across its operating speed range. The second speed-torque curve B is an illustrative example of a generated speed-torque curve, which exemplifies the torque that can be generated by a single actuator-type system across the same operating speed range.

In typical applications the relationship between the absolute values of speed and torque are such that both the demand speed-torque curve A and the generated speed-torque curve B have similar characteristics, in that high torques can be required or generated at lower speeds, and that high speeds can be required or generated with lower torques. As shown, the generated curve B is greater than or equal to the demand curve A, thus allowing the mechanical joint to properly function.

Specifically referring to the demand speed-torque curve A, the mechanical joint system can have two boundary conditions at either end of the curve. The left-most boundary condition 220 corresponds to the maximum torque that may be required of the mechanical joint. As can be appreciated by one having skill in the art, the biomimetic mechanical joint can have a maximum torque (e.g. low-speed/high-torque) boundary condition which corresponds to applying a maximum torque with very little motion. A physical example could be rotating the support member while lifting a heavy load, or climbing a staircase with all the weight momentarily carried by one leg. In order to rotate the same support member with more speed, however, the load on the mechanical joint decreases, as illustrated by following the demand speed-torque curve A to the right, towards the other end of the plot. The right-most boundary condition 230 corresponds to the maximum design rotational speed (e.g. high-speed/low-torque) of the support member about the pivot device. In the physical world, this is the fastest rotation that can be accomplished when the support member is moved solely against the influence of its own weight, or base gravity loading.

The envelope of the demand speed-torque curve A can be continuous and smooth, without any sudden breaks or steps, between the maximum torque boundary condition 220 and maximum speed boundary condition 230. Moreover, the demand speed-torque curve A has a generally downwardly-bowed shape, which is the typical of the torque demanded by a mechanical joint while moving through the operating speed range of the system. The region 216 bounded by the X-axis, Y-axis and the demand curve A can define the normal operating range of the biomimetic mechanical joint, with demand curve A defining the maximum torque demanded at any particular speed. Points below demand curve A also fall within the operating range, and can be reached by throttling or otherwise reducing the power to the joint.

The generated speed-torque curve B can illustrate the torque provided by a single, 100% actuator system which has been configured to meet both the maximum design torque (or boundary condition) 220 and the maximum design speed (or boundary condition) 230 of the mechanical joint. The generated speed-torque curve B can be representative of both hydraulic and electrical actuator systems. In physical terms of a hydraulic system, the effective actuation area of the cylinder can be made large enough to generate a force sufficiently large to reach the maximum design torque 220, while at the same time, the associated servo-valve or control system can be given enough through-put capacity to quickly fill the cylinder and move the joint at the maximum design speed 230.

As can be seen in FIG. 5, the generated speed-torque curve B can have the same general left-to-right downward-sloping form as the demand speed-torque curve A. The generated speed-torque curve B produced by the actuator system can also have a generally upwardly-bowed shape, which is typical of the torque provided by the single, 100% actuator system moving through the operating speed range of the joint. The upwardly-bowed shape of the generated curve B is characteristic of many actuation systems. The difference between the two curves, as identified by the region 234, illustrates the inefficiency and oversize requirement that is inherent within a mechanical joint driven by a single, 100% actuator system.

When the single actuator is configured to meet both extreme boundary conditions of the joint, e.g. the maximum design torque 220 and the maximum design speed 230, excess power will be wasted during operation at the representative locations on the curve between the two end points, as indicated by the region 234 between curves A and B. In a hydraulic system, this lost power can be manifested as high pressure fluid that is throttled as it passes through the servo-valve controlling the actuator. In a motorized system, this lost power can be manifested as wasted electrical power and excess heat that is generated as the motor operates at a less efficient voltage level.

Under optimum conditions the area 234 would be the principle loss or inefficiency between the generated speed-torque curve B and the demand speed-torque curve A. However, in many circumstances it is not possible for a single actuator to be configured to meet both boundary conditions 220 and 230. In such conditions prior related systems are invariably designed around the maximum torque boundary condition 220 and left oversized for the maximum speed boundary condition 230. This has the affect of moving the optimum generated speed-torque curve B to an actual generated speed-torque curve position B′, and the generated torque at the high-speed/low-load boundary condition from the optimum capability 230 to an oversized capability 230′. This results in additional wasted energy when the actuator is operated at higher speeds, as exemplified by region 236. In physical terms of the hydraulic actuation system example, the wasted energy can be embodied in the excess high-pressure hydraulic fluid that is required to move the large-diameter hydraulic piston under a little or no load.

Shown in FIG. 6 is a plot 240 illustrating the benefits gained from configuring a biomimetic mechanical joint with a plurality of fractional actuators according to the method the present invention. In an exemplary embodiment, instead of designing a single, 100% actuator to meet the boundary conditions 220, 230 of the joint with inefficient operation between boundary conditions, the single 100% actuator can be divided into two factional actuators, one of which provides generated speed-torque curve C and the other which provides generated speed-torque curve D. Operating in combination, the two fractional actuators together can provide the generated speed-torque curve C+D. Although each fractional actuator still has the upwardly-bowed shape characteristic of the single actuator, the angle of the curve and degree of curvature can be configured to provide a better approximation of the demand speed-torque curve A, both individually and in combination. In another aspect of the biomimetic mechanical joint, the single actuator can be divided into three or more fractional actuators.

The small fractional actuator providing the generated speed-torque curve C can be configured to meet the maximum speed (high-speed/low-torque) boundary condition 230 of the mechanical joint. By way of an illustrative example, generated speed-torque curve C could be produced by the small antagonistic actuator pair 120 described in FIGS. 2-4. The fractional actuator and its associated control system 112 could be sized (or speed rated) to provide enough high-pressure hydraulic fluid to the hydraulic cylinder to move the small actuator piston 122 at a speed sufficient to rotate the mass of the structural member 102, without any additional loading, about the pivot device 140 at a rotational velocity that equals the maximum speed boundary condition 230 (see FIG. 6). By using only the small antagonistic actuator pair 120 to rotate the structural member 102 under such conditions, the difference between the maximum torque that can be generated and the required torque is reduced, so that only the minimum amount of high-pressure hydraulic fluid is used. This results in less wastage in comparison to other cylinder configurations.

It can also be appreciated that the small actuator can be continuously throttled to provide a more efficient power source for all operating points falling below speed-torque curve C, or within region 242, even those at a slow speed.

The generated speed-torque curve D could be produced by the large antagonistic actuator pair 130 described in FIGS. 2-4. With its larger size hydraulic cylinders, the large fractional actuator can assume sole operation of the biomimetic mechanical joint whenever the demand torque is greater than generated speed-torque curve C, but still less than the maximum required of the joint. Referring to FIG. 6, generated speed-torque curve D can be the optimum actuator selection between operating points 226 and 228. The large fractional actuator can also be continuously throttled to provide a more efficient power source for all operating points between speed-torque curves C and D, or within region 244.

Both fractional actuators would not need to be recruited together unless the biomimetic mechanical joint encountered an operating point that demanded more torque than could be provided by the single large actuator, as would be the case for all operating points falling inside the region 246, located to the left of point 226 and between demand speed-torque curve A and generated speed-torque curve D. As this dual-actuator region only covers a small portion of the entire operating range of the mechanical joint, it can readily be seen that significant energy savings can be realized with a biomimetic mechanical joint configured according to the method of the present invention, as the actuation system could be operated with either the large or small fractional actuator in single-actuator operation over the majority of the operating range of the joint.

According to the method of the present invention, the small (or first) fractional actuator can be configured first to meet the demands of the maximum speed boundary condition. After sizing, or rating, the small fractional actuator for the maximum speed condition, the large (or second) fractional actuator can be sized by subtracting the maximum torque rating of the small fractional actuator from the maximum torque boundary condition of the biomimetic mechanical joint to arrive at the maximum torque rating of the large fractional actuator.

This method can be graphically illustrated in FIG. 6, which shows that speed-torque curve C generated by the small fractional actuator has two end points or ratings, the maximum speed rating 230 which matches the maximum speed requirement of demand curve A, and the small fractional actuator's individual maximum torque rating 224. The value of the individual maximum torque rating 224 generated by the small fractional actuator can then be subtracted from the combined maximum torque 220 required by the biomimetic mechanical joint to arrive at the individual maximum torque rating 222 of the large fractional actuator. The large fractional actuator can be sized (or rated) to meet this low-speed/high-torque operating condition.

The method of configuring the biomimetic mechanical joint can be applied to any mechanical joint utilizing fractional actuators, regardless of the type of power source for the actuator, e.g. whether first and second actuators are hydraulic actuators, motors, etc. Moreover, the method can be applied to any configuration for the first and second fractional actuators, including but not limited to antagonistic, single-acting linear actuator pairs, dual-acting linear actuators, rotary actuators, etc.

The method of the present invention can also be aligned with various pre-defined operating states for the exoskeleton or human-like robot. In an exemplary application of the present invention to the leg of the exoskeleton or human-like robot, these operating states can include a stepping mode, a squatting mode, a walking mode, a running mode, and a stumble-recovery mode. Furthermore, the maximum torque and maximum speed boundary conditions for the biomimetic mechanical joint can correspond with the stepping mode and stumble-recovery mode, respectively.

For instance, the stepping mode can correspond with the maximum torque boundary condition as this is the operating state in which all the weight of the exoskeleton or human-like robot, including the weight of an occupant and any extra gear, is supported on one leg when the leg is bent. An example of the stepping mode is climbing up a set of stairs, in which each leg must alternately operate to support and lift the entire weight of the exoskeleton or human-like robot.

Likewise, the stumble-recovery mode can correspond with the maximum speed boundary condition, as this is the operating state in which the joints of the leg must be able to extend rapidly, either forward or backward, to catch and brace the human-like robotic body from a fall. Under these circumstance, all the weight is supported by the other leg, and the first leg only needs to overcome its own inertia and gravity effects in reaching maximum rotational speed.

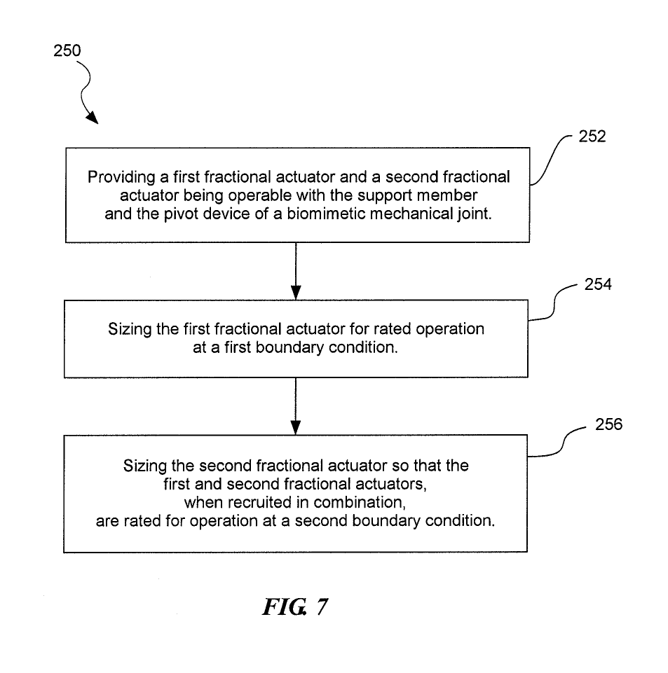

With reference to FIG. 7, illustrated is a flowchart depicting a method 250 of configuring a biomimetic mechanical joint for efficient movement of a support member about a pivot device, in accordance with an exemplary embodiment of the present invention. The method can include the operations of providing 252 a first fractional actuator and a second fractional actuator being operable with the support member and the pivot device of the biomimetic mechanical joint, and sizing 254 the first fractional actuator for rated operation at a first boundary condition. The first boundary condition can correspond with the maximum design speed of the support member about the pivot device under base gravity loading. Thus, the first fractional actuator can be speed rated to meet the maximum speed boundary condition of the biomimetic mechanical joint.

The method can further include the operation of sizing 256 the second fractional actuator so that the first and second fractional actuators, when recruited in combination, are rated for operation at a second boundary condition. The second boundary condition can correspond with a maximum design torque of the support member about the pivot device under maximum design loading. The second fractional actuator can be torque rated by subtracting the torque rating of the first fractional actuator from the maximum torque boundary condition of the joint to arrive at the torque rating of the second fractional actuator.

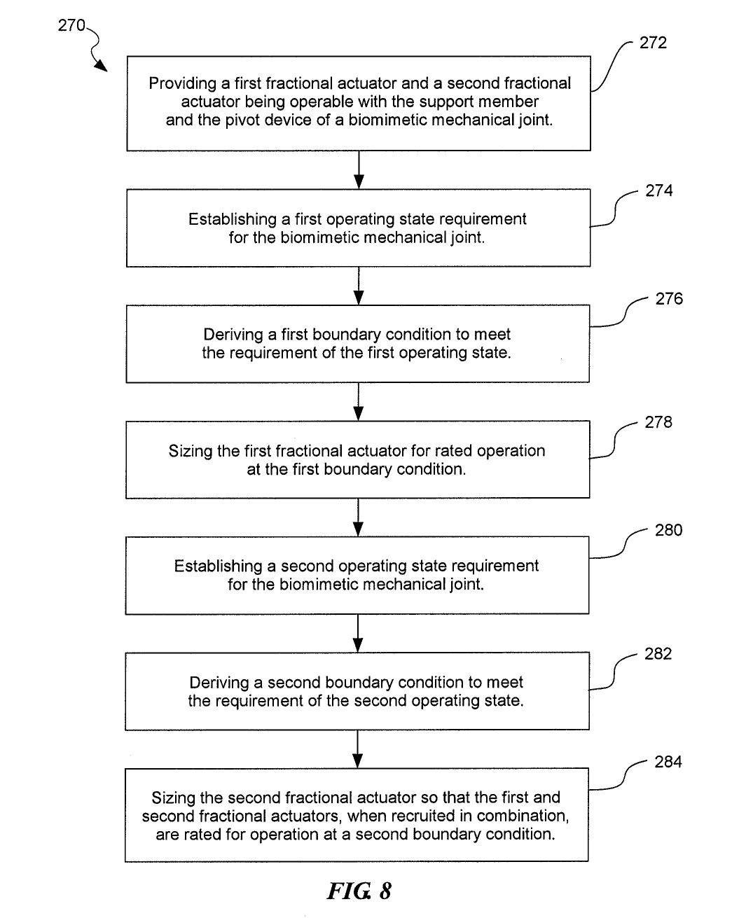

Illustrated in FIG. 8 is a flowchart depicting another method 270 of configuring a biomimetic mechanical joint for efficient movement of a support member about a pivot device, in accordance with yet another exemplary embodiment of the present invention. The method can include the operation of providing 272 a first fractional actuator and a second fractional actuator being operable with the support member and the pivot device of the biomimetic mechanical joint. The method can further include the steps of establishing 274 a first operating state requirement for the biomimetic mechanical joint, deriving 276 a first boundary condition to meet the requirement of the first operating state, and sizing 278 the first fractional actuator for rated operation at the first boundary condition. In one aspect of the present invention, the first operating state can correspond to the biomimetic mechanical joint moving in a stumble-recovery mode, from which can be derived the first boundary condition corresponding to the maximum design speed of the support member about the pivot device under base gravity loading.

The method 270 can further include the operations of establishing 280 a second operating state requirement for the biomimetic mechanical joint, deriving 282 a second boundary condition to meet the requirement of the second operating state, and sizing 284 the second fractional actuator so that the first and second fractional actuators, when recruited in combination, are rated for operation at a second boundary condition. In another aspect of the present invention, the second operating state can correspond to the biomimetic mechanical joint moving in a stepping mode, from which can be derived the second boundary condition corresponding with the maximum design torque of the support member about the pivot device under maximum design loading.

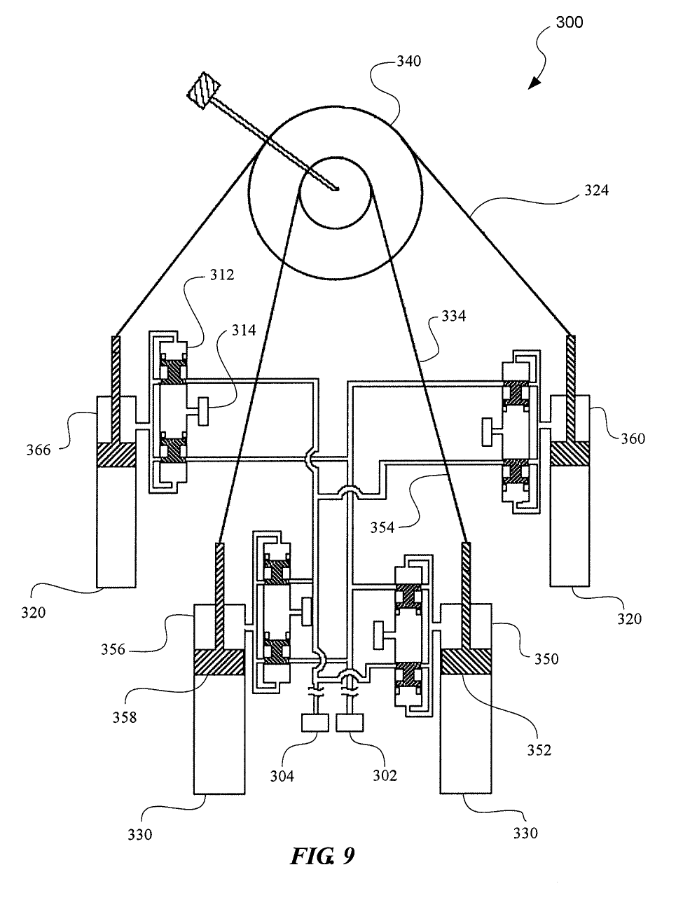

As stated above, if either the first or the second fractional actuators are selectively recruited at any particular moment in time to power the biomimetic mechanical joint, the actuator not recruited at that instant can be selectively disengaged or disconnected from the mechanical joint to prevent unnecessary drag on the active portion of the actuator system. This selective disengagement can include fluidic disengagement between the actuators and the pivot device, physical disconnection of the actuators from the pivot device, or electrical disconnection between a motor and a power supply, etc. Illustrated in FIG. 9 is a schematic diagram of an exemplary biomimetic mechanical joint 300 which has been sized according to an exemplary embodiment of the method of the present invention, and which can further demonstrate the fluidic disconnection of the non-active actuator from the biomimetic mechanical joint during single actuator operation.

In the exemplary embodiment of a biomimetic mechanical joint 300 illustrated in FIG. 9, the pivot device 340 is acted upon by a small antagonistic actuator pair 320 and a large antagonistic actuator pair 330, both of which are connected to the pivot device with tendons 324, 334. Each individual actuator in each antagonistic actuator pair can be a single-acting, linear hydraulic actuator, which can be connected at the head end of the hydraulic cylinder to a pressure control valve (PCV) 312 operable with a pilot valve 314. The PCVs and pilot valves can be configured so that the inactive antagonistic actuator pair operates in accordance with a “slosh” mode, which allows the hydraulic fluid contained in the inactive antagonistic actuator pair to shunt back and forth between the two single-acting hydraulic cylinders without consuming or performing work. In other words, the inactive actuator pair can be configured for idle operation by selecting the PCVs for slosh mode, which can effectively disengage the fractional actuator from the system so that it does not contribute as a drag or brake on the biomimetic mechanical joint.

The hydraulic system which can utilize two antagonistic actuator pairs, in conjunction with corresponding PCVs and pilot valves, to allow for active operation of one actuator pair and slosh mode operation of the other, is described in more detail in commonly-owned and co-pending U.S. patent application Ser. No. 12/074,261, filed Feb. 28, 2008, entitled “Fluid Control System Having Selective Recruitable Actuators;” and Ser. No. 12/074,260, filed Feb. 28, 2008, entitled, “Antagonistic Fluid Control System for Active and Passive Actuator Operation,” which applications are incorporated by reference in their entirety herein.

With reference to the actuation system illustrated in FIG. 9, the selectively recruitable and disengagable actuators can be operated in single fractional actuator (e.g. antagonistic actuator pair) mode. For instance, high-pressure hydraulic fluid from a fluid source 302 can be directed into one actuator cylinder 350 of an active actuator pair (in this case, large fractional actuator pair 330), expanding the cylinder chamber and pushing the actuator piston 352 away from the head end of the cylinder to pull on the active tendon 354 and rotate the pivot device 340. The opposite end of the active tendon 334 can be connected to the cylinder 356, which actuator piston 358 is pulled toward the head end of the cylinder 356, contracting the cylinder volume and discharging the hydraulic fluid contained within the cylinder to the low pressure return reservoir 304.

At the same time the volume of the opposite actuator cylinder 366 in the inactive antagonistic actuator pair 320 is also contracting, but instead of the fluid discharging to the return reservoir, the fluid can be shunted to the inactive actuator cylinder 360 adjacent the first fractional actuator 350 in the active actuator pair, which allows the inactive actuator 360 to passively react and follow along with the first active actuator 350. This is advantageous, because if at some point in mid-stroke the torque demand on the joint is suddenly increased, the inactive actuator pair is already in position and filled with fluid, and instantly available to activate and contribute to pulling on the pulley device 340 without having to move and take up slack in the tendon.

As stated above, both fractional actuators can be continuously throttled when driving the mechanical joint. Consequently, it is to be appreciated that a biomimetic mechanical joint having the capability for the selective recruitment/disengagement and the continuous throttling of two fractional actuators results in an actuation or drive system with two control degrees-of-freedom. This can be advantageous by allowing the mechanical joint to reach various operating points with one or more actuator recruitment configurations and throttle settings, of which the most efficient can be selected.

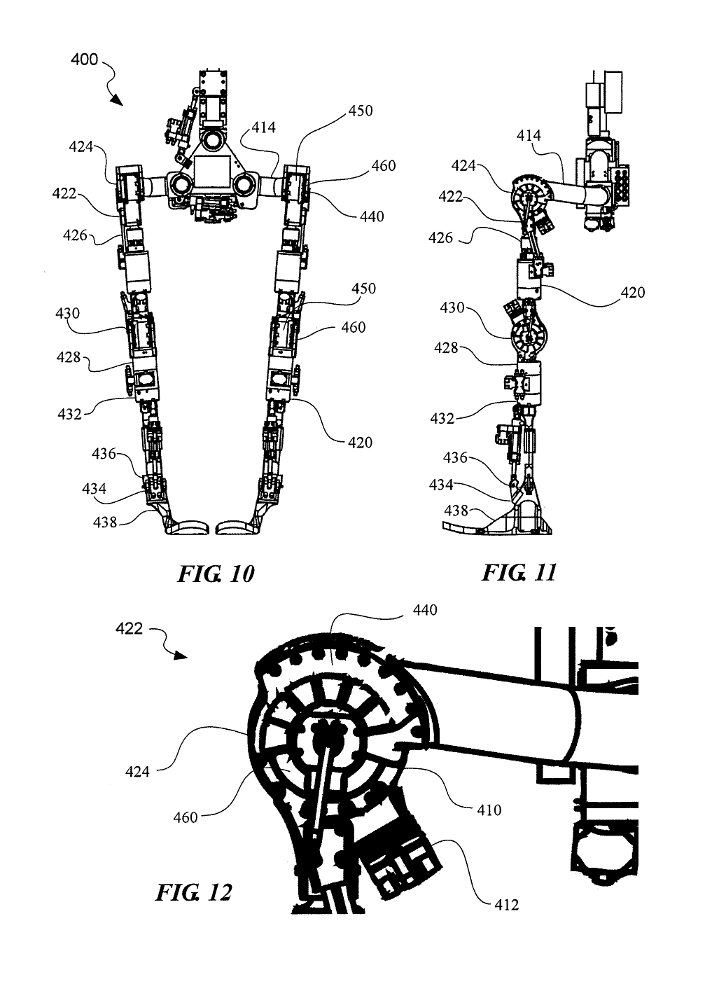

The method of the present invention can be applied to any robotic device having biomimetic mechanical joints configured with a plurality of fractional actuators, including fractional actuators that are distinguishable from the two antagonistic actuator pairs shown in FIGS. 2-4 and 9. For example, illustrated in FIGS. 10-12 is an exemplary lower body portion exoskeleton 400 having biomimetic mechanical joints configured with rotary fractional actuators pairs 450, 460, such as rotary vane hydraulic devices or rotary motors, that have been sized according to the method of the present invention.

Similar to the lower body portion of the exoskeleton in FIG. 1, the human-like robotic device 400 can include a pelvic region 414 to which are attached the two legs 420, each of which can be further comprised of a hip joint 422, a knee joint 428 and an ankle joint 434. As previously stated, each biomimetic mechanical joint can be defined as the assembly which includes the pivot device and the attached, rotary support member. As such, the biomimetic mechanical hip joint 422 can therefore comprise the hip pivot device 424 and the upper leg or thigh support member 426, the knee joint 428 can comprise the knee pivot device 430 and the lower leg or calf support member 432, and the ankle joint 434 can comprise the ankle pivot device 436 and the foot support member 438.

The lower body portion exoskeleton 400 of FIGS. 10-12 can be distinguished from the human-like robotic device of FIG. 1, however, in that the plurality of fractional actuators 450, 460 can be integrated within the pivot devices 440 of the hip 422 and knee 428 joints, and not connected via tendons, cables, linkages or other coupling methods. In the rotary actuator case, a control body 412 for the actuator sub-assembly 410 can extend outwardly from the pivoting device/rotary actuators. (In the exemplary exoskeleton 400, the ankle joint 432 can still comprise linear actuators.) Using rotary actuators for one or more joints can reduce the size of the actuator sub-assembly 410 to nearly the size of the pivot device 440.

In a biomimetic mechanical joint having rotary actuators, the plurality of fractional rotary actuators can further comprise a large rotary actuator 450 and a small rotary actuator 460, which can both be concentric with each other and integrated into the pivot device 440. The large rotary actuator can have a greater width along its axis of rotation than the smaller actuator, for containing the larger internal elements needed to generate more torque. Both the large and small rotary actuators can be individually recruited for and disengaged from driving the mechanical joint. Furthermore, both actuators can be continuously throttled when driving the mechanical joint. As with the biomimetic mechanical joint having two fractional antagonistic actuator pairs, the capability for selective recruitment/disengagement and continuous throttling of each rotary actuator creates an actuation or drive system with two control degrees-of-freedom.

The method of the present invention can be applied to the biomimetic mechanical joint having two rotary actuators. The small rotary actuator 460 can be configured (or speed rated) to meet the maximum speed boundary condition of the mechanical joint, after which the large actuator 450 can be configured (or torque rated) by subtracting the maximum torque rating of the small actuator from the maximum torque boundary condition of the joint to arrive at the maximum torque rating of the large actuator.

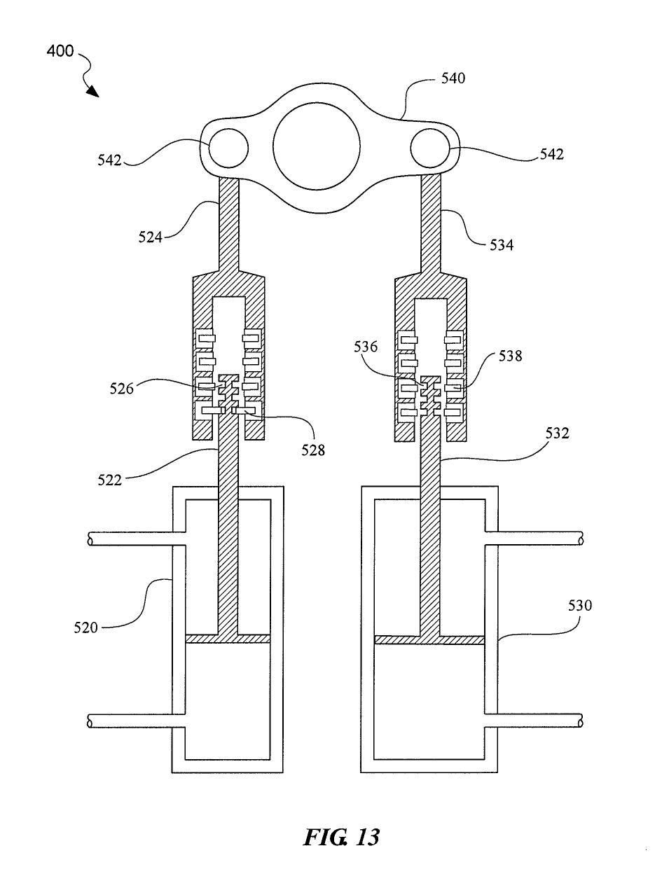

FIG. 13 provides a sectional view of yet another exemplary biomimetic mechanical joint 500 which can be sized according to the method of the present invention. The mechanical joint 500 can be comprised of two fractional, double-acting, linear actuators, including one small fractional actuator 520 and one large fractional actuator 530, which can act separately or in unison to rotate a pivot device 540 about a pivot axle 542. The linear, double-acting fractional actuators can be connected to the pivot device with a rigid linkage that allows the fractional actuators to drive the pivot device, and hence the mechanical joint, in both directions. Furthermore, the linear, double-acting fractional actuators can be hydraulic actuators, linear motors, etc.

As shown in FIG. 13 for illustrative purposes, and not by way of limitation, the actuator pistons 522, 532 can be provided with a means for mechanically engaging and disengaging the actuators 520, 530 from the pivot device 540. For example, the actuator pistons can be selectively coupled with a sleeve linkage 524, 534 that is further connected to the pivot device with pivot pins 544. The actuator pistons can be configured with receiving devices, such as notches, 526, 536, into which can be inserted attaching devices, such as locking pins 528, 538. One or both of the linear, double-acting actuators can then be selectively recruited into driving the biomimetic mechanical joint by engaging the receiving device 526 and attaching device 528 to create a rigid connection between the linear, double-acting actuator 520 and the pivot device 540.

The receiving and attaching devices used for mechanical engagement can be located on the actuator pistons and sleeve linkages, respectively as shown, or the arrangement can be reversed. In another aspect of the biomimetic mechanical joint 500 the means for mechanical engagement can be included in the pivot device itself, such as with a selectively engageable clutch mechanism and the like. Moreover, the receiving and attaching devices can be engaged or disengaged at any point of travel between the actuator and the pivot device. Thus, it is to be appreciated that the means for mechanical engagement can include any similar receiving and attaching device known to one of skill in the art, including extendable collars, electromagnetic clamps, mechanical or electromagnetic clutches, etc., which can be used to mechanically engage and disengage the double-acting hydraulic actuators 520, 530 from the pivot device 540.

In another aspect of the present invention, the biomimetic mechanical joint 500 can be provided with linear, double-acting hydraulic actuators having PCVs and pilot valves configured so that the inactive actuator can be operable with the PCV in “slosh” mode. Slosh mode can allow the hydraulic fluid contained in the inactive fractional actuator to shunt back and forth between the two ends of the double-acting hydraulic cylinder without consuming or performing work. In other words, the actuator can be configured for idle operation by selecting the PCVs and pilot valves for slosh mode, to provide fluidic disengagement, instead of mechanical disconnection, of the actuator from the actuation system so minimize drag on the biomimetic mechanical joint.

The method of the present invention can also be applied to the biomimetic mechanical joint illustrated in FIG. 13. The small actuator 520 can be configured (or speed rated) to meet the maximum speed boundary condition of the mechanical joint, after which the large actuator 530 can be configured (or torque rated) by subtracting the maximum torque rating of the small actuator from the maximum torque boundary condition of the biomimetic mechanical joint to arrive at the maximum torque rating of the large actuator.

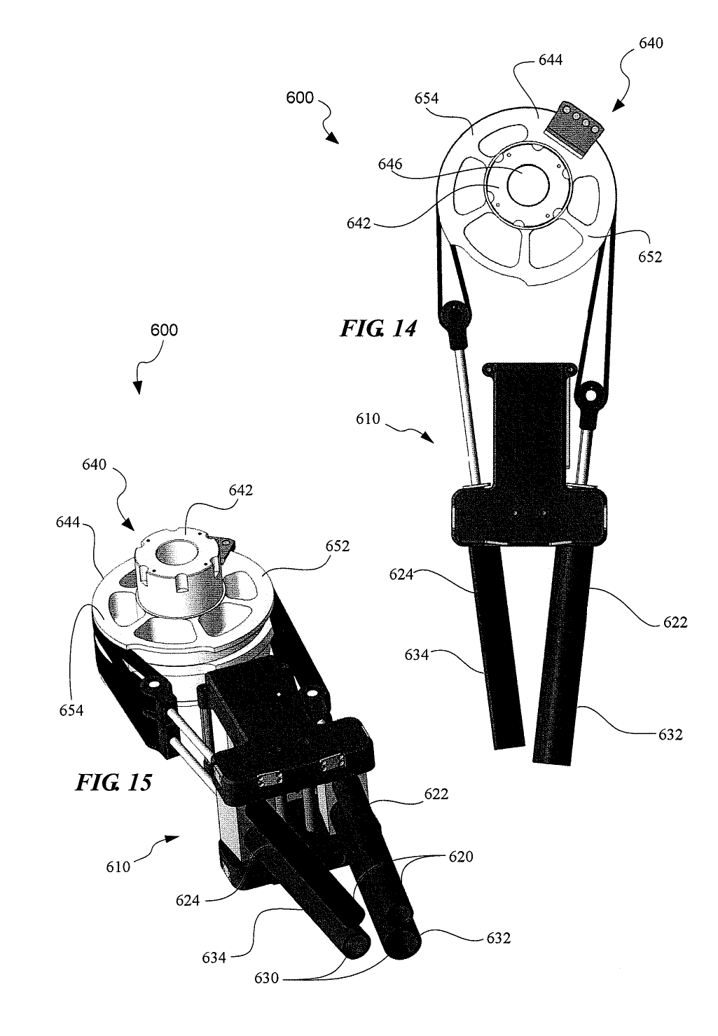

Illustrated in FIGS. 14 and 15 is another exemplary biomimetic mechanical joint 600 which can also be sized according to the method of the present invention. The biomimetic mechanical joint 600 is similar to the joint illustrated in FIGS. 2-4 and 9, in that the joint can be powered by two fractional antagonistic actuator pairs 620 and 630. However, the mechanical joint 600 is distinguishable from the previously-discussed joint in that the pivot device 640 can be a variable-radius (“VR”) pulley 644 with an eccentric axle portion 642 and center hole 646. The mechanical joint 600 is further distinguishable in that each actuator in both antagonistic actuator pairs can be differentially sized from each of the other actuators in the actuator sub-assembly 610, in order to take further advantage of the leveraging aspects of the variable-radius pulley and better emulate the performance of the natural joint.

By way of example, the small fractional antagonistic actuator pair 620 can have a large-radius actuator 622 which, when recruited, rotates the variable-radius pulley 644 using a large-radius portion of the 652 of the VR pulley, and a small-radius actuator 624 which, when recruited, rotates the pivot device using the small-radius portion of the 654 of the VR pulley. In a similar fashion, the large, fractional antagonistic actuator pair 630 can have a large-radius actuator 632 and small-radius actuator 634 operating about the large-radius portion 652 and small-radius portion 654 of the variable-radius pulley, respectively.

The large-radius actuators 622, 632 can be differentially sized from their related small-radius actuators 624, 634 to take advantage of the mechanical advantage provided by the variable-radius pulley 644 and better emulate the performance of the natural joint. For instance, a natural joint may be capable of providing greater torque when moved in one direction verses the other (for instance, the quadriceps muscles can be significantly stronger than the hamstring muscles when rotating an upper leg member about the hip joint). When the variable-radius pulley 644 is assembled with an actuator sub-assembly 610 having differentially sized actuator pairs 622, 624 and 632, 634, the performance characteristics of the mechanical joint can be modified and extended, and may become dependent upon the direction of rotation of the mechanical joint. Consequently, the resulting biomimetic mechanical joint can better emulate the performance and efficiency of the natural joint.

Additionally, the variable-radius pulley can be formed with multiple tendon grooves or journal surfaces having different diameters, as well as non-circular or elliptical shapes that are rotated or offset relative each other. The differences in the sizes and/or shapes between the tendon grooves can be used in combination with differences in the sizing of each antagonistic actuator or actuator pair to provide additional flexibility in modifying and extending the performance characteristics of the mechanical joint. Consequently, the variable torque characteristics of the biomimetic mechanical joint can further depend upon the direction of rotation and lead to a mechanical joint that better mimics the performance and efficiency of the natural joint.

The fractional actuators 620, 630 of the biomimetic mechanical joint 600, moreover, can still be sized according to an exemplary embodiment of method of the present invention. For instance, the small antagonistic actuator pair 620 can be sized (or speed rated) to meet the demands of the maximum speed boundary conditions, wherein each actuator 622, 624 in the small antagonistic actuator pair 620 can be speed rated to a different maximum speed boundary condition based of the direction of rotation of the support member about the pivot device.

After rating the small antagonistic actuator pair 620 for the maximum speed conditions, the large antagonistic actuator pair 630 can be sized (or torque rated) by subtracting the maximum torque rating of the small actuators 622, 624 from the maximum torque boundary conditions of the biomimetic mechanical joint, to arrive at the maximum torque rating of the actuators 632, 634, wherein each actuator 632, 634 in the large antagonistic actuator pair 630 can be torque rated to a different maximum torque boundary condition based of the direction of rotation of the support member about the pivot device.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given above.

What is claimed and desired to be secured by Letters Patent is:

1. A method of configuring a biomimetic mechanical joint for efficient movement of a support member about a pivot device, the method comprising:
providing first and a second actuators being operable with the support member and the pivot device;
sizing the first actuator for rated operation at a first boundary condition;
sizing the second actuator so that the first and second actuators, when recruited in combination, are rated for operation at a second boundary condition.

2. The method of claim 1, wherein the first boundary condition corresponds with a maximum design speed of the support member about the pivot device under a minimum design loading condition.

3. The method of claim 2, wherein the minimum design loading condition is selected from the group consisting of a base gravity loading, inertial loading, friction loading and combinations of these.

4. The method of claim 1, wherein the second boundary condition corresponds with a maximum design torque of the support member about the pivot device under a maximum design loading condition.

5. The method of claim 3, wherein a maximum design torque rating of the first actuator is subtracted from the maximum design torque to arrive at the maximum design torque rating of the second actuator.

6. The method of claim 1, further comprising selectively recruiting one of the first and second actuators and selectively disengaging the other of the first and second actuators during operation between the first and second boundary conditions.

7. The method of claim 6, wherein selectively disengaging the other of the first and second actuators comprises selecting a slosh mode of a pressure control valve operable with the other actuator.

8. The method of claim 6, wherein selectively disengaging the other of the first and second actuators further comprises mechanically decoupling the other actuator from the pivot device.

9. The method of claim 1, wherein the first and second actuators further comprise one of first and a second rotary actuators coupled together to form the pivot device, and first and second dual-acting actuators coupled to the pivot device via at least one rigid linkage.

10. (canceled)

11. The method of claim 1, wherein the first and second actuators further comprise a first and second antagonistic actuator pair, wherein each antagonistic actuator pair is coupled together about the pivot device via a tendon.

12. The method of claim 11, wherein each actuator in the first antagonistic actuator pair is sized to a different first boundary condition based on the direction of rotation of the support member about the pivot device.

13. The method of claim 11, wherein each actuator in the second antagonistic actuator pair is sized to a different second boundary condition based on the direction of rotation of the support member about the pivot device.

14. (canceled)

15. (canceled)

16. The method of claim 1, further comprising:
providing at least three actuators being operable with the support member and the pivot device; and
sizing a second and a third actuators so that the at least three actuators, when recruited in combination, are rated for operation at a second boundary condition.

17. A method of configuring a biomimetic mechanical joint for efficient movement of a support member about a pivot device, the method comprising:
providing first and a second actuators being operable with the support member and the pivot device;
establishing a first operating state requirement for the biomimetic mechanical joint;
deriving a first boundary condition to meet the requirement of the first operating state;
sizing the first actuator for rated operation at the first boundary condition;
establishing a second operating state requirement for the biomimetic mechanical joint;
deriving a second boundary condition to meet the requirement of the second operating state;
sizing the second actuator so that the first and second actuators, when recruited in combination, are rated for operation at the second boundary condition.

18. (canceled)

19. The method of claim 17, wherein the first operating state corresponds to the biomimetic mechanical joint moving in a stumble-recovery mode, and wherein the first boundary condition derived from the stumble-recovery mode corresponds with a maximum design speed of the support member about the pivot device under a base gravity loading.

20. (canceled)

21. The method of claim 17, wherein the second operating state corresponds to the biomimetic mechanical joint moving in a stepping mode.

22. The method of claim 21, wherein the second boundary condition derived from the stepping mode corresponds with a maximum design torque of the support member about the pivot device under a maximum design loading.

23. The method of claim 22, wherein a maximum design torque rating of the first actuator is subtracted from the maximum design torque of the support member about the pivot device to arrive at the maximum design torque rating of the second actuator.

24. The method of claim 17, further comprising configuring the first and second actuators for selective recruitment, as well as selective disengagement during operation between the first and second boundary conditions.

25. The method of claim 17, wherein the first and second actuators further comprise one of first and a second rotary actuators, respectively, coupled together to form the pivot device, and first and second dual-acting actuators, respectively, coupled to the pivot device with at least one rigid linkage.

26. (canceled)

27. (canceled)
